(19) United States
(12) Patent Application Publication
(10) Pub. No.: US 2014/0238092 A1
(43) Pub. Date: Aug. 28, 2014

(54) Method for Producing a Crown of a Golf Club Head

(71) Applicant: FUSHENG PRECISION CO., LTD., Taipei City (TW)

(72) Inventors: Chien-Liang Li, Taipei City (TW); Chih-Wei Lo, Taipei City (TW)

(73) Assignee: FUSHENG PRECISION CO., LTD., Taipei City (TW)

(21) Appl. No.: 14/188,721

(22) Filed: Feb. 25, 2014

(30) Foreign Application Priority Data
Feb. 28, 2013 (CN) 201310062818.1

(51) Int. Cl. B21D 53/00; B24C 1/04; B23C 3/13; B21D 13/02

(52) U.S. Cl. CPC B21D 53/00; B21D 13/02; B24C 1/04; B23C 3/13
USPC 72/40; 72/340; 72/341; 72/46

(57) ABSTRACT

A method for producing a crown of a golf club head is provided to solve the disadvantages of high manufacturing costs of conventional production of the crown. The method includes a material preparation step including preparing a sheet material to be processed, with the sheet material including a first surface and a second surface opposite to the first surface. The method further includes a formation step including press-shaping the sheet material obtained from the material preparation step at least one time by at least one mold, forming at least one rib on the first surface of the sheet material. The method further includes a milling step including milling the second surface of the sheet material obtained from the formation step, obtaining a crown for a golf club head.

### BACKGROUND OF THE INVENTION

1. Field of the Invention

The present invention relates to a method for producing a part of a golf club head and, more particularly, to a method for producing a crown of a golf club head.

2. Description of the Related Art

A golf club head, which is light and which has a low and deep center of gravity, generally has a larger sweet spot and, thus, provides enhanced hitting performance. Reduction in the thickness of the crown of the golf club head can effectively reduce the weight of the whole golf club head. However, a crown that is too light and too thin is apt to deform and damage. Thus, ribs are generally provided on an inner side of the crown to form a structure with uneven thickness at the inner side for the purposes of reinforcing the crown.

There are two common methods currently used to form a structure with uneven thickness at the inner side of the crown of a golf club head. One of the methods uses a computer numerical control (CNC) machine to read electronic drawing files and uses various cutters to directly proceed with three dimensional (3D) cutting. The other method uses acid wash to corrode the crown with a strong acid for forming the structure with uneven thickness.

However, the first method using cutting is restricted by the cutters such that slight differences exist between the outline of the product and the outline of the design in the 3D drawing files. Furthermore, stress concentration exists in the acute angles generated during cutting by the cutters, adversely affecting the strength of the crown. Furthermore, a large amount of waste material is cut from the sheet material by direct cutting, causing a waste in the material and a high consumption rate of the cutters while having a long processing time in manufacture (cutting processing of a crown takes about 8 minutes) that results in difficulties in increasing the yield. Thus, many manufacturers can only increase the yield by increasing the number of CNC machines at the cost of occupying a large space and causing considerable expenses in purchase and maintenance of the CNC machines.

On the other hand, the second method using acid washing tends to leave serrated acute angles on the surfaces of the sheet material, which also causes stress concentration and adversely affects the strength of the crown. Furthermore, the strong acid used in the acid washing process causes a burden to the environment.

Thus, a need exists for improvement to current methods for manufacturing a crown of a golf club head.

### SUMMARY OF THE INVENTION

An objective of the present invention is to provide a method for producing a crown of a golf club head, wherein at least one rib is shaped on a surface of a crown, and the other surface is then milled, saving the costs and increasing the yield.

The present invention fulfills the above objective by providing a method for producing a crown of a golf club head. The method includes a material preparation step including preparing a sheet material to be processed, with the sheet material including a first surface and a second surface opposite to the first surface; a formation step including press-shaping the sheet material obtained from the material preparation step at least one time by at least one mold; and a milling step including milling the second surface of the sheet material obtained from the formation step, obtaining a crown for a golf club head.

The formation step includes a rough mold formation step and a precision mold formation step. A mold having a simple curved face is used to shape the sheet material in the rough mold formation step. A mold having a more precisely curved face is used to shape the sheet material in the precision mold formation step.

The method can further include a shaping step after the milling step. The shaping step includes passing the sheet material through a mold having a curvature to shape an outer face of the sheet material into an arcuate shape.

The method can further include a surface cleaning step after the shaping step. The surface cleaning step includes sandblasting the first and outer surfaces of the sheet material to remove oxides and/or impurities on the first and outer surfaces of the sheet material.

The formation step can further include forming an anti-oxidation layer on each of the first and second surfaces of the sheet material before press-shaping the sheet material.

The shaping step can further include forming an anti-oxidation layer on each of the first and outer surfaces of the sheet material before shaping the first and outer surfaces of the sheet material.

A thickness difference between the thickest portion and the thinnest portion is more than 0.2 mm.

A rib is formed on the first surface of the sheet material in the precision mold formation step and has a width more than 0.5 mm.

Preferably, the rib includes an upper edge having a rounded corner with a size more than 0.25 mm.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a flowchart illustrating a method for producing a crown of a golf club head according to the present invention.

FIG. 2a is a cross sectional view of a sheet material for producing a crown of a golf club head according to the present invention.

FIG. 2b is a cross sectional view of the sheet material after a rough mold shaping step.

FIG. 2c is a cross sectional view of the sheet material after a precision mold shaping step.

FIG. 2d is a cross sectional view of the sheet material after a milling step.

FIG. 2e is a cross sectional view of the sheet material after a post treatment step.

### DETAILED DESCRIPTION OF THE INVENTION

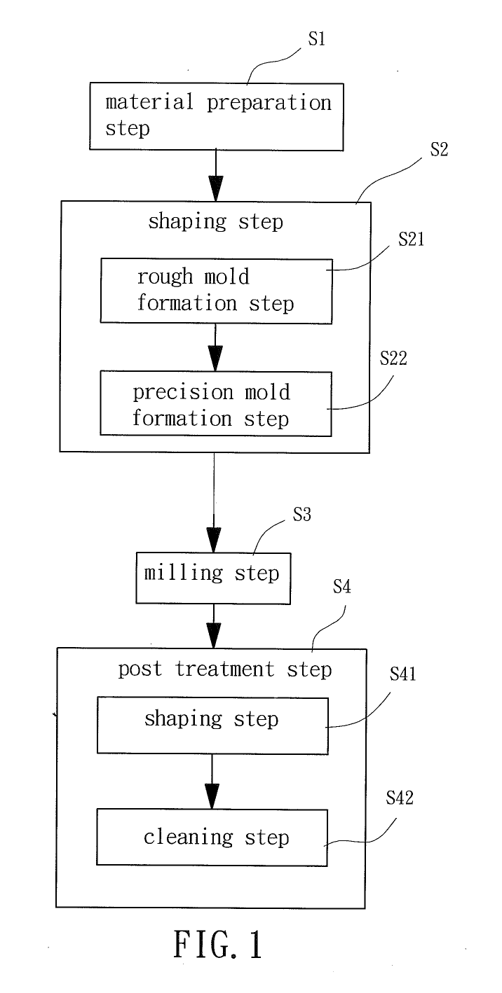

With reference to FIG. 1, a method for producing a crown of a golf club head according to the present invention includes a material preparation step S1, a formation step S2, and a milling step S3. The formation step S2 includes pressing a surface of a sheet material obtained from the material preparation step S1 to obtain a structure with uneven thickness. The other surface of the sheet material is milled in the milling step S3 to form a crown including the structure with uneven thickness.

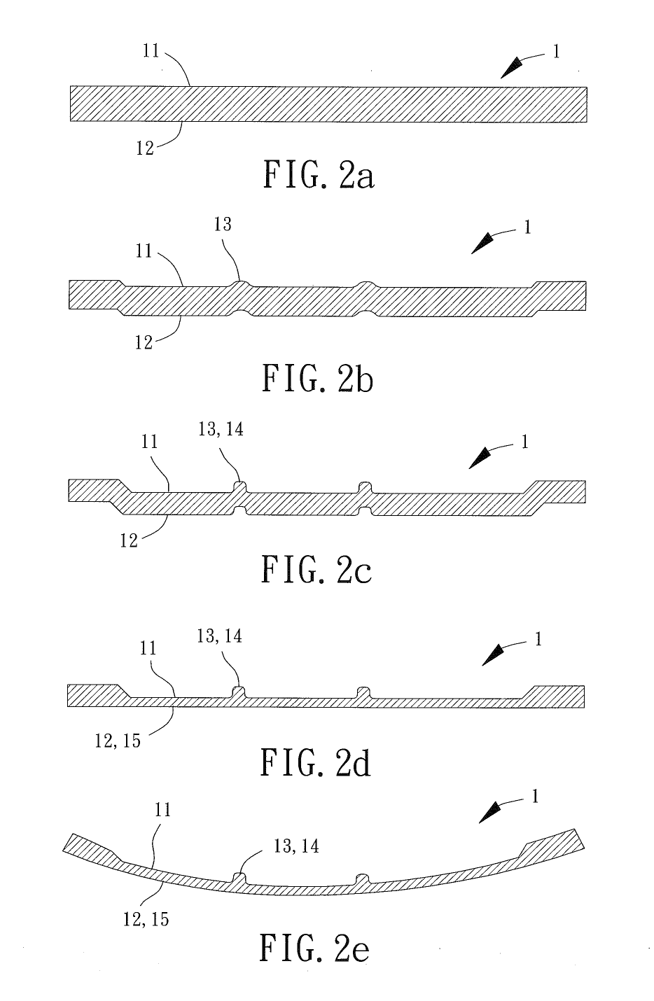

With reference to FIGS. 1 and 2a, the material preparation step S1 includes preparing a sheet material 1 to be processed. Specifically, in this embodiment, a cutting machine (such as a laser cutting machine) is used to cut a substrate into a plurality of sheet materials 1 for subsequent processing to form a product having a contour similar to an outline of the sheet materials 1.

The sheet material 1 includes a first surface 11 and a second surface 12 opposite to the first surface 11. Preferably, the sheet material 1 is made of a metal having a higher deforming capability or higher shocking capability, such as carbon steel, stainless steel (such as 17-4PH stainless steel), alloy steel, nickel-based alloy, cast iron, super alloy steel, Fe—Mn—Al alloy, titanium alloy, copper alloy, aluminum alloy, magnesium alloy, or combinations thereof.

With reference to FIGS. 1 and 2b, the formation step S2 includes placing the sheet material 1 obtained from the material preparation step S1 in a mold and processing the sheet material 1 by at least one pressing or forging to obtain the sheet material 1 having a structure with uneven thickness 13. In this embodiment, the sheet material 1 is forged, and the formation step S2 includes a rough mold formation step S21 and a precision mold formation step S22.

In the rough mold formation step S21, a mold having a simple curved face is used to shape the sheet material 1. Specifically, the sheet material 1 and the mold having a simple curved face are heated, and the sheet material 1 is placed into the mold and press-shaped by the mold to provide the sheet material 1 with a curved shape and to form the structure with uneven thickness 13 on the first surface 11 of the sheet material 1. The heating temperature for the sheet material 1 and the mold can be set according to the material of the sheet material 1, which can be appreciated by one having ordinary skill in the art, and the heating temperature preferably does not exceed the crystallization temperature of the sheet material 1.

Furthermore, an anti-oxidation layer can be selectively formed on a surface of the sheet material 1 according to the material characteristics of the sheet material 1 for reducing oxides generated during heating and shaping of the sheet material 1. Namely, an anti-oxidization layer is preferably formed on the surface of the sheet material 1 if the sheet material 1 is made of an easy-to-oxidize metal (such as titanium). Conversely, it is not necessary to form an anti-oxidization layer on the surface of the sheet material 1 if the sheet material 1 is made of a metal that does not oxidize easily (such as steel). In this embodiment, an anti-oxidization agent is sprayed onto the first and second surfaces 11 and 12 of sheet material to form the anti-oxidization layer after the anti-oxidization agent dries.

Likewise, if the sheet material 1 is made of an easy-to-oxidize metal, before the precision mold formation step S22, an anti-oxidization layer is preferably coated on the first and second surfaces 11 and 12 of the sheet material 1 obtained from the rough mold formation step S21 to provide the deformation area of the sheet material 1 with an anti-oxidization effect. Conversely, it is not necessary to form an anti-oxidation layer on the surface of the sheet material 1 obtained from the rough mold formation step S21 if the sheet material 1 is made of a metal that does not oxidize easily.

With reference to FIGS. 1 and 2c, a mold having a more precisely curved face is used in the precision mold formation step S22 to shape the sheet material 1. Specifically, since a temperature drop phenomenon occurs when the sheet material 1 obtained from the rough mold formation step S21 flows in the production line. The temperature could even drop to room temperature. Thus, when carrying out the precision mold formation step S22, the sheet material 1 and the mold having a more precisely curved face must be pre-heated to a temperature not exceeding the crystallization temperature of the sheet material 1. Then, the sheet material 1 is placed into the mold and is press-shaped to obtain the sheet material 1 having the structure with uneven thickness 13. At this time, the structure with uneven thickness 13 is substantially the same as the predetermined shape, and at least one rib 14 is formed on the first surface 11 of the sheet material 1. In this embodiment, the rib 14 has a width more than 0.5 mm. An upper edge of the rib 14 has a rounded corner with a size more than 0.25 mm.

With reference to FIGS. 1 and 2d, the milling step S3 includes milling the second surface 12 of the sheet material 1 by using a machine tool, forming an outer surface 15. In this embodiment, the sheet material 1 obtained from the precision mold formation step S22 is cooled to an appropriate temperature (such as room temperature), and a computer numerical control machine and appropriate cutters are used to mill the second surface 12 of the sheet material 1 into a smooth surface serving as the outer surface 15 of a crown for a golf club head. A thickness difference between the thickest portion and the thinnest portion of the sheet material 1 is more than 0.2 mm.

The sheet material 1 can have the structure with uneven thickness 13 by the formation step S2, and the smooth outer surface 15 of the sheet material 1 can rapidly be obtained by the milling step S3. Thus, the present invention can significantly reduce the waste material cut from the sheet material 1, saving the material costs and reducing the burden to the milling machine as well as reducing the consumption rate of the cutters. Furthermore, three dimensional milling can be replaced with two dimensional milling to reduce the processing time (shaping processing of a crown merely takes 3 minutes) and costs, effectively increasing the yield.

With reference to FIGS. 1 and 2e, a post treatment step S4 can be carried out after the milling step S3 to trim the sheet material 1, obtaining a high-quality crown product for a golf club head. Specifically, the post treatment step S4 includes a shaping step S41 and a surface cleaning step S42.

In the shaping step 41, a die having a curvature is used to shape the outer surface 15 of the sheet material 1 such that the outer surface 15 can have an appropriate curvature for coupling with a golf club head. In this embodiment, the sheet material 1 obtained from the milling step S3 and the die having a curvature are heated, and the sheet material 1 is placed into the mold. The outer surface 15 of the sheet material 1 is shaped by the die into an arcuate shape.

Since a portion of the second surface 12 of the sheet material 1 is removed in the milling step S3, the anti-oxidization layer on this portion of the second surface 12 is also removed. In a case that the sheet material 1 is made of an easy-to-oxidize metal, a new anti-oxidization layer is preferably coated on each portion of the surfaces 11 and 15 of the sheet material 1 by spraying the surfaces 11 and 15 with an anti-oxidization agent, providing an anti-oxidization effect.

After the shaping step S41, the surface cleaning step S42 can be carried out to sandblast the surfaces 11 and 15 of the sheet material 1 by silica sands, aluminum oxide, iron sands, aluminum beads, or iron beads, removing the oxides and/or impurities formed on the surfaces 11 and 15 of the sheet material 1 and completing formation of the crown for a golf club head according to the present invention. If desired, a type number, words, or trademark can be formed on a surface (such as the outer surface 15) of the sheet material 1 by laser carving to improve the product identification effect.

In view of the foregoing, the method for producing a crown of a golf club head according to the present invention can firstly form at least one rib 14 on the first surface 11 of the sheet material 1 and then mill the second surface 12 of the sheet material 1 to form the crown for a golf club head. The waste material cut from the sheet material 1 is significantly reduced to save the material costs, to reduce the consumption rate of the cutters, and to reduce the processing time, saving the manufacturing costs and increasing the yield. Furthermore, the method according to the present invention does not involve acid wish procedures and is, thus, eco-friendly.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for producing a crown of a golf club head comprising:
a material preparation step including preparing a sheet material to be processed, with the sheet material including a first surface and a second surface opposite to the first surface;
a formation step including press-shaping the sheet material obtained from the material preparation step at least one time by at least one mold; and
a milling step including milling the second surface of the sheet material obtained from the formation step, obtaining a crown for a golf club head.

2. The method for producing a crown of a golf club head as claimed in claim 1, wherein the formation step includes a rough mold formation step and a precision mold formation step, a mold having a simple curved face is used to shape the sheet material in the rough mold formation step, and a mold having a more precisely curved face is used to further shape the sheet material in the precision mold formation step.

3. The method for producing a crown of a golf club head as claimed in claim 1, further comprising: a shaping step after the milling step, with the shaping step including passing the sheet material through a mold having a curvature to shape an outer face of the sheet material into an arcuate shape.

4. The method for producing a crown of a golf club head as claimed in claim 3, further comprising: a surface cleaning step after the shaping step, with the surface cleaning step including sandblasting the first and outer surfaces of the sheet material to remove oxides and/or impurities on the first and outer surfaces of the sheet material.

5. The method for producing a crown of a golf club head as claimed in claim 1, wherein the formation step further includes forming an anti-oxidation layer on each of the first and second surfaces of the sheet material before press-shaping the sheet material.

6. The method for producing a crown of a golf club head as claimed in claim 3, wherein the shaping step further includes forming an anti-oxidation layer on each of the first and outer surfaces of the sheet material before shaping the first and outer surfaces of the sheet material.

7. The method for producing a crown of a golf club head as claimed in claim 1, wherein the crown includes a thickest portion and a thinnest portion, and a thickness difference between the thickest portion and the thinnest portion is more than 0.2 mm.

8. The method for producing a crown of a golf club head as claimed in claim 1, wherein a rib is formed on the first surface of the sheet material in the precision mold formation step, and the rib has a width more than 0.5 mm.

9. The method for producing a crown of a golf club head as claimed in claim 1, wherein a rib is formed on the first surface of the sheet material in the precision mold formation step, and the rib includes an upper edge having a rounded corner with a size more than 0.25 mm.
